(19) United States
(12) Patent Application Publication
(10) Pub. No.: US 2019/0069717 A1
(43) Pub. Date: Mar. 7, 2019

(54) AUTOMATIC BEVERAGE APPARATUS

(71) Applicant: THE HILL DEVELOPMENT TECH CO., LTD., London (GB)

(72) Inventor: Chi-Yang Yeh, New Taipei City (TW)

(21) Appl. No.: 16/111,199

(22) Filed: Aug. 23, 2018

(30) Foreign Application Priority Data
Sep. 4, 2017 (TW) 106213115

(51) Int. Cl. A47J 31/52

(52) U.S. Cl. CPC A47J 31/52

(57) ABSTRACT

An automatic beverage apparatus includes an ordering operation unit and host computer, where the ordering operation unit includes beverage, ice and sugar menus, where the beverage menu includes beverages, the ice and sugar menus set the ice volume and sugar amount corresponding to the first and second beverages, and the beverage, ice and sugar menus respectively output a beverage signal after selection. The host computer is in electric connection with a cup dropping machine, label machine, ice maker, first additive device, fructose machine, jam machine, second additive device, milk machine, beverage device, sealing machine and cup shaking device, where the cup dropping machine outputs a cup, the label machine sticks a label corresponding to the beverage onto the cup, a transmission unit moves the cup to below the above elements to receive the selected objects, and the cup shaking device clamps, rotates the cup after it is sealed.

### (A) TECHNICAL FIELD OF THE INVENTION

The present invention relates to an automatic beverage apparatus, and more particularly to an automatic beverage apparatus capable of preparing beverages in sequence according to various menus.

### (B) DESCRIPTION OF THE PRIOR ART

There are many handmade drink stores in the market, the sweetness, coldness or composition ratio of beverages can be customized in the stores. But, beverage preparation in a manual way always makes prepared beverages not conform to personal requirements due to errors and different experiences of drink makers. In addition, handmade drink stores need more labors, resulting in high labor cost.

### SUMMARY OF THE INVENTION

In view of the above shortcomings, the present invention proposes an automatic beverage apparatus, including an ordering operation unit and host computer, where the ordering operation unit includes at least one beverage menu, ice menu and sugar menu, where the beverage menu includes at least one first beverage, the ice menu and sugar menu are adapted to set the ice volume and sugar amount corresponding to the first beverage and second beverage, and the beverage menu, ice menu and sugar menu respectively output a first beverage signal after selection. The host computer is in electric connection with a cup dropping machine, label machine, ice maker, first additive device, fructose machine, jam machine, second additive device, milk machine, beverage device, sealing machine and cup shaking device, where the cup dropping machine outputs at least one cup, the label machine sticks a first label corresponding to the first beverage onto the first cup, a transmission unit moves the cup to below the ice maker, first additive machine, fructose machine, jam machine, second additive device, milk machine, beverage device and sealing machine to receive ice cubes, fructose, jam, first and second additives, milk and beverage, the sealing machine is used to seal the cup, and the cup shaking device clamps, rotates the cup, and at the same time, moves it to an order pickup area.

With the automatic beverage apparatus of the present invention, standard, stable and hygienic beverages can be prepared, and the labor cost can be reduced.

### BRIEF DESCRIPTION OF THE DRAWINGS

FIG. 1 is a structural block diagram of an ordering operation unit of the present invention;

FIG. 2 is a perspective view of a preferred embodiment of the present invention;

FIG. 3 is a perspective view of a cup dropping machine and label machine of the present invention;

FIG. 4 is a perspective view of the cup dropping machine and an ice maker of the present invention;

FIG. 5 is a perspective view of a first additive device of the present invention;

FIG. 6 shows FIG. 5 in a use state;

FIG. 7 is a schematic view of a first type of a second additive device of the present invention;

FIG. 8 is a perspective view of a second type of the second additive device of the present invention;

FIG. 9 is a perspective view of a cup shaking device of the present invention; and

FIG. 10 is a structural block diagram of a transmission device of the present invention.

### DETAILED DESCRIPTION OF THE PREFERRED EMBODIMENTS

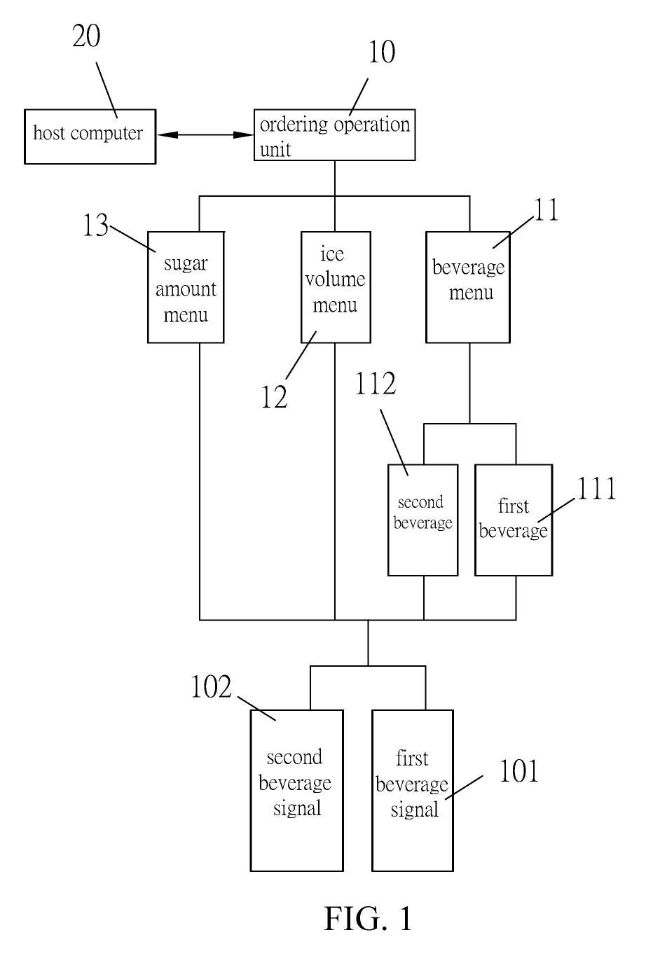

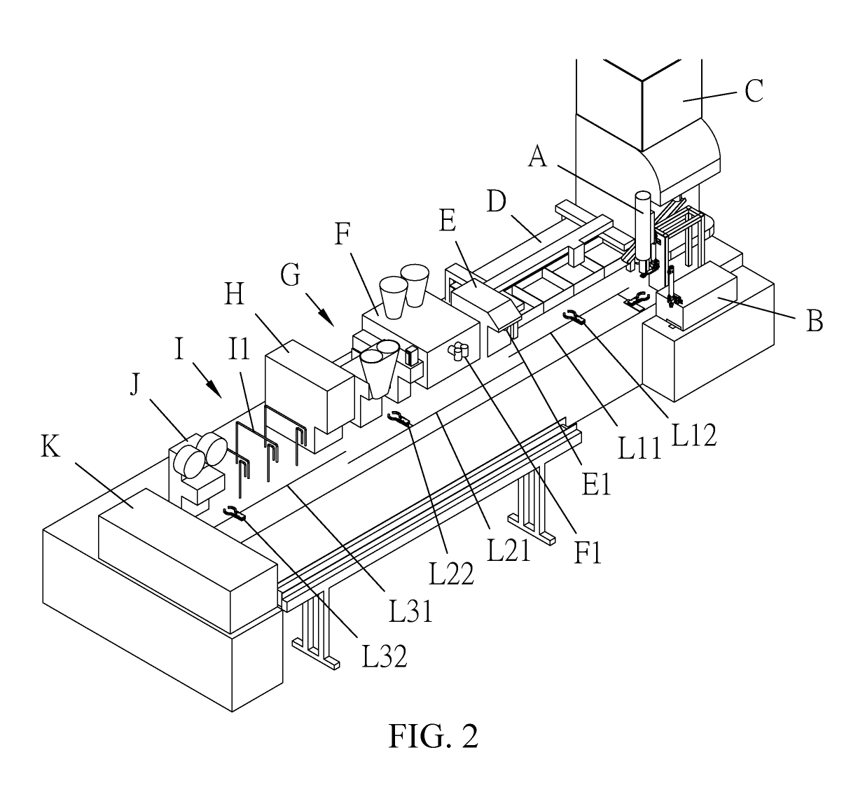

Referring to FIGS. 1 and 2, an automatic beverage apparatus of the present invention includes an ordering operation unit 10, host computer 20, cup dropping machine A, label machine B, ice maker C, first additive device D, fructose machine E, jam machine F, second additive device G milk machine I, beverage device I, sealing machine J and cup shaking device K.

Referring to FIG. 1, the ordering operation unit 10 includes at least one beverage menu 11, ice menu 12 and sugar menu 13, where the beverage menu 11 includes at least one first beverage 111 and at least one second beverage 112, where the ice menu and sugar menu are adapted to set the amount of ice and the amount of sugar corresponding to the first beverage 111 and the second beverage 112, and the beverage menu 11, ice menu 12 and sugar menu 13 respectively output a first beverage signal and second beverage signal 102 after they all are selected.

The host computer 20 is in electric connection with the ordering operation unit 10 to receive the first beverage signal 101 and second beverage signal 102, and the host computer 20 provides first additive information, jam amount information, and second additive information corresponding to the first beverage 11 or second beverage 112.

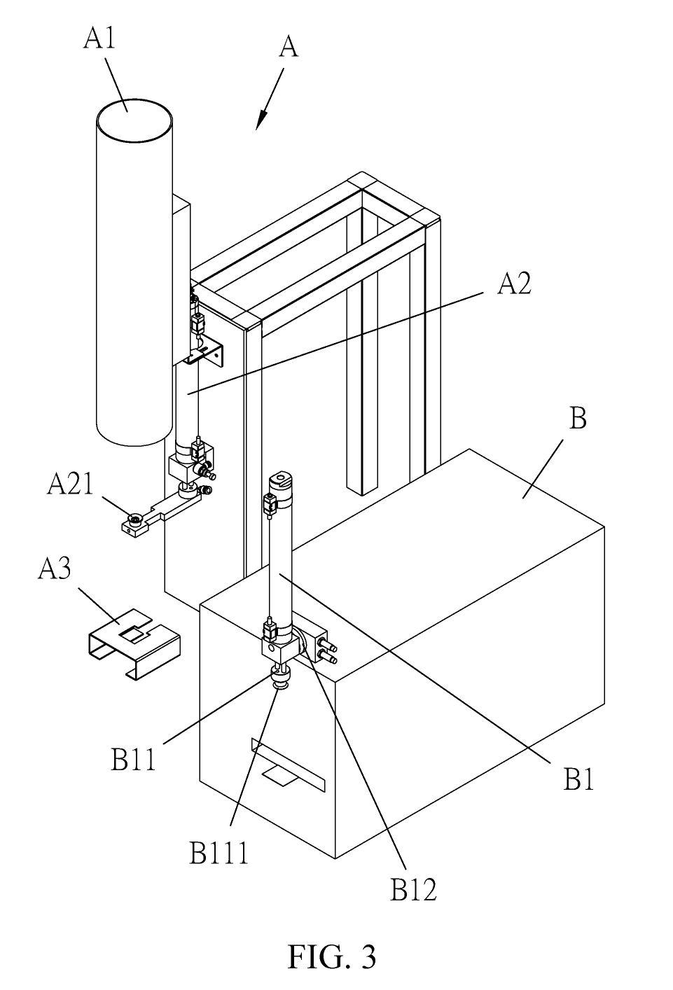

Referring to FIGS. 2 and 3, the cup dropping machine A includes a tube A1, lifting unit A2 and platform A3, where the tube A1 is used to accept a plurality of cups (not shown in the figures), the lifting unit A2 is configured at one side of the tube A1 and driven to take down a first cup (not shown in the figures) and second cup (not shown in the figures) in sequence after receiving the first beverage signal 101 and second beverage signal 102; the platform A3 is positioned below the tube A1 and adapted to allow the first cup and second cup to be placed on it, and a push unit A4 is configured on one side of the platform A3.

The lifting unit A2 is configured with a sucking disk A21 facing the bottom of the tube A1, adapted to draw the bottom of the first cup; the lifting unit A21 is lowered down to cause the first cup to be separated from the tube A1 and the lifting unit A2 is then caused to rise and return after the first cup or second cup is placed on the platform A3, which is adjacent to a transmission unit L.

The label machine B is positioned adjacently to the cup dropping machine A and in electric connection with the host computer 20. In addition, the label machine B is in electric connection with a label take-up unit B1 adapted to output a first label (not shown in the figures) corresponding to the first beverage 111 and a second label (not shown in the figures) corresponding to the second beverage 112 after receiving the first beverage signal 101 and second beverage signal 102; the label take-up unit B1 takes up the first label and second label in sequence and sticks the first label and second label onto the first cup and second cup in sequence; and the push unit A4 is driven to move the first cup away from the platform A3 after the first label is stuck on the first cup to allow the second cup to enter the platform A3.

Furthermore, the label take-up unit B1 of the label machine B includes a reciprocating telescopic device B11 and motor B12, where the reciprocating telescopic device B11 is configured with a sucking disk B111 adapted to draw the first label or second label, and the motor B12 is adapted to drive the reciprocating telescopic device B11 to rotate and move toward the platform A3; a label on the sucking disk B111 is caused to be adhered on the first cup or second cup by extending the reciprocating telescopic device.

The ice maker C is in electric connection with the host computer 20 and adapted to make, store and output ice cubes (not shown in the figures). The ice maker C further has an ice cube outlet C1, and the first cup is positioned below the ice cube outlet C1; the transmission unit L moves the first cup, and the second cup is moved to below the ice cube outlet C1 at the same time after the first cup is filled with ice cubes.

A guide unit C2 having a slope is further configured below the ice cube outlet C1, and the first cup or second cup is positioned at the tail end of the guide unit C2 so as to pick up ice cubes, where an electronic scale in electric connection with the ice maker C is further configured below the ice cube outlet C1 or below the guide unit C2, and the first cup and second cup are placed on the electronic scale C3. The ice maker C3 is caused to stop outputting ice cubes when the weight of the ice cubes received on the electronic scale C3 reaches the ice amount of the first beverage 111 or second beverage 112.

The first additive device D is in electric connection with the host computer 20 and adapted to store at least one first additive (not show in the figures), which may be nata, pearl tapioca or the like. The first additive device also includes a first mechanical arm D1; the transmission unit L moves the first cup and second cup in sequence to the front of the first additive device, and the host computer 20 drives the first mechanical arm D1 selectively to dig out the first additive and place it into the first cup or second cup according the first additive information.

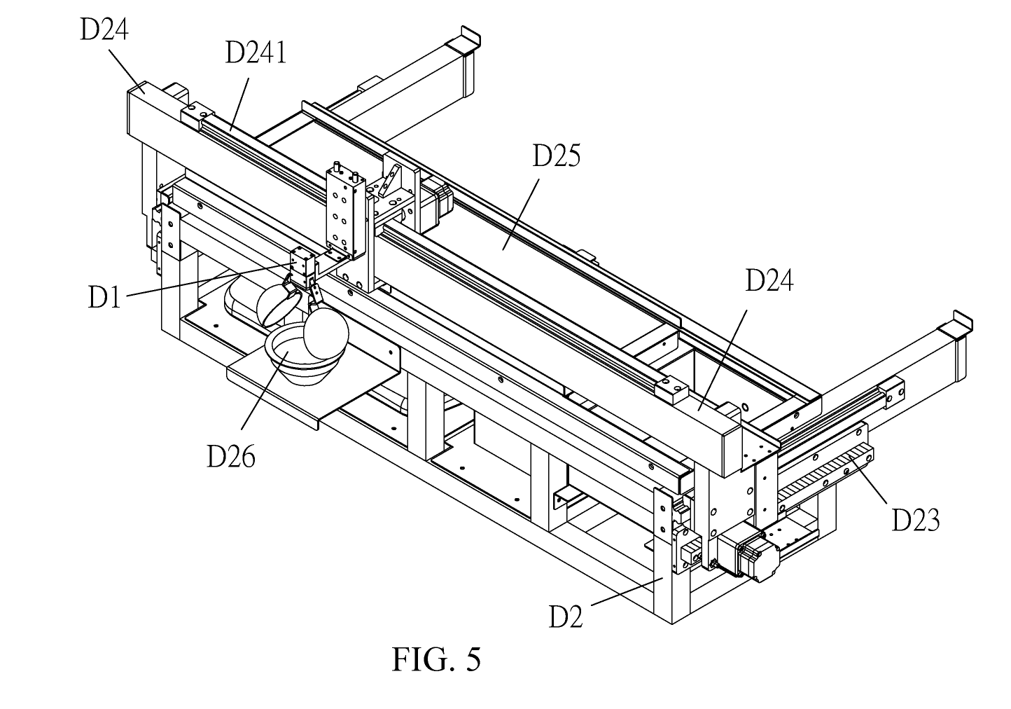

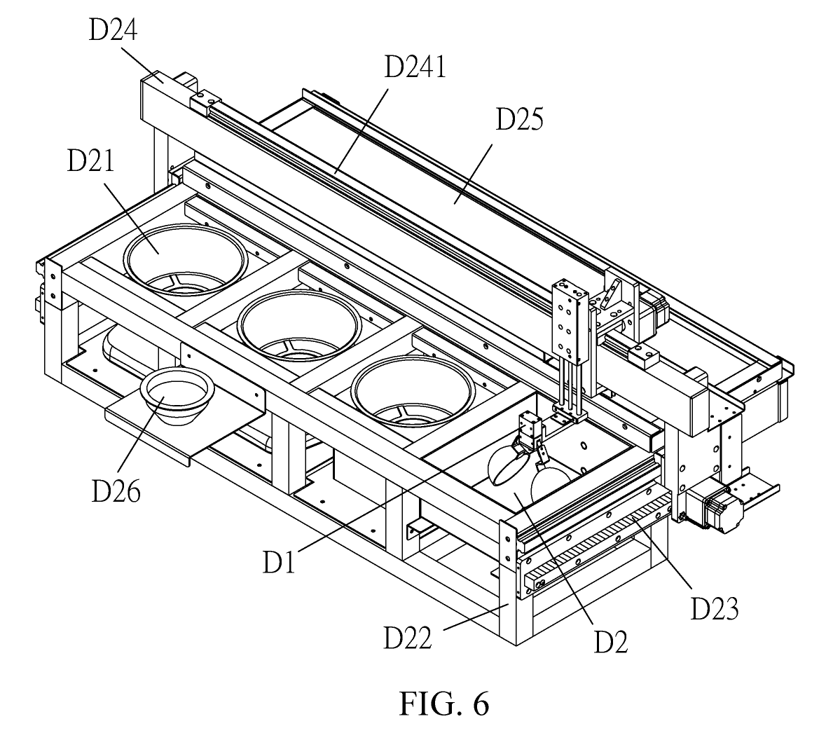

Referring to FIGS. 5 and 6, the first additive device D includes a box D2, inside which at least one storage tank D21 and cleaning tank D22 are configured, where the first storage tank D21 is used to store the first additive, and the cleaning tank D22 cleaning fluid (clean water). Furthermore, the two sides of the box D2 are respectively configured with a longitudinal rail D23 in combination a frame D24, allowing the frame D24 to be reciprocated along the longitudinal rail D23, where a transverse rail D241 is configured on the frame D24, and the first mechanical arm D1 is configured on the transverse rail D241, allowing the first mechanical arm D1 to be reciprocated.

The top face of the box D2 is configured with a cover D25, on which is configured with a connecting element (not shown in the figures), and the top end of the connecting element is in combination with the bottom face of the frame D24, thereby allowing the cover D25 to be separated from or closed on the box D2 when the frame D24 is reciprocated longitudinally.

The front side of the box D2 is protruded with a funnel D26, thereby placing the first additive into the funnel D26 after the first mechanical arm D1 digs out the first additive and dropping it into the first cup or second cup through the funnel D26.

The fructose machine E is in electric connection with the host computer 20 and adapted to store fructose (not shown in the figures). The fructose machine E also has a fructose outlet E1, and the transmission unit L moves the first cup and second cup in sequence to below the fructose outlet E1. Thereafter, the fructose machine E respectively output an amount of sugar corresponding to the first beverage 111 into the first cup and an amount of sugar corresponding to the second beverage 112 to the second cup according to the first beverage signal 101 and second beverage signal 102.

The jam machine F is in electric connection with the host computer 20 and adapted to store jam (not shown in the figures). The jam machine F also has a jam outlet F1, and the transmission unit L moves the first cup and second cup in sequence to below the Jam outlet F1. Thereafter, the host computer 20 drives the jam machine F selectively to output jam into the first cup or second cup according to the jam amount information.

The second additive device G is in electric connection with the host computer 20 and adapted to store at least one second additive (not shown in the figures), which may be small fruit cubes or fruit slices. Furthermore, the second additive device G has at least one second additive outlet G1, and the transmission unit L moves the first cup and second cup in sequence to below the second additive outlet G1, thereafter, the host computer 20 drives the second additive device G selectively to output at least one second additive into the first cup or second cup according to the second additive information.

In the embodiment, a first type of the second additive device G is: the second additive device G has at least one accommodation tank G2, first block plate G3 and second block plate G4, where the second additive outlet G1 is configured on the bottom of the accommodation tank G2, the first block plate G3 is used to close the second additive outlet G1, and the accommodation tank G2 is configured with a slot G21 adapted for the installment of the second block plate G4, allowing the accommodation tank G2 to be partitioned into a first accommodation space G22 and second accommodation space G23, where the first accommodation space G22 and second accommodation space G23 store the second additive, and the first block plate G3 and second block plate G4 are connected to a first air cylinder G31 and second air cylinder 41, respectively; the host computer 20 drives the first air cylinder G31 to cause the first block plate G3 to be separated from the second additive outlet G1, allowing the second additive to drop into the first cup or second cup; the first block plate G3 is moved by the first air cylinder G31 to close the second additive outlet G1; the second air cylinder G41 drives the second block plate G4 to cause the second additive in the first accommodation space G22 to drop into the second accommodation space G23, and the second air cylinder 41 is then used to drive the second block plate G4 to pass through the slot G21 to enter the accommodation tank G2. The first type of the second additive device G is used to accommodate small fruit cubes.

A second type of the second additive device G is: the second additive device G has at least one hollow accommodation cylinder G5 adapted to store the second additive, the bottom of which is configured with a screw rod G51 adapted to push the second additive to move; the second additive outlet G1 is configured on the top of the accommodation cylinder G5, and the second additive outlet G1 is configured with a push air cylinder G6 adapted to push the second additive to move, allowing the second additive to drop into the first cup or second cup through the second additive outlet G1.

The first and second types of the second additive device G can be used alternatively or concurrently according to user's requirements.

The milk machine H is in connection with the host computer 20 and adapted to set the milk amount corresponding to the first beverage 111 or second beverage 112. The milk machine H also outputs milk selectively into the first cup or second cup.

The beverage device I is in electric connection with the host computer 20 and adapted to store a plurality of beverages (not shown in the figures), which include green tea, black tea, milk tea, etc. and has a plurality of beverage outlets 11; the transmission unit L moves the first cup and second cup to below the beverage outlets 11, and the host computer 20 drives the beverage device I to output the beverage corresponding to the first beverage 111 into the first cup and the beverage corresponding to the second beverage 112 into the second cup according to the first beverage signal 101 and second beverage signal 102.

The sealing machine J is in electric connection with the host computer 20 and installed with a plurality of sealing films (not shown in the figures), and the transmission L moves the first cup and second cup in sequence to below the sealing machine J. Thereafter, the sealing machine J respectively outputs a sealing film to seal the first cup and second cup.

The cup shaking unit K is in electric connection with the host computer 20 and includes a second mechanical arm K1, which takes and rotates the first cup and second cup and places them into an order pickup area 30.

The cup shaking device K includes a housing K2, motor (not shown in the figures) having a transmission shaft K3, a sliding rail K4 and a rack K5, where the motor K3 is configured in the housing K2, and the transmission shaft K31 is extended to the outside of the housing K2; the transmission shaft K31 is configured with a gear K311, and the second mechanical arm K1 is configured on the transmission shaft K31; the housing K2 is extended out with a suspension arm K21 slidably configured on the sliding rail K4, and the rack K5 is positioned below the sliding rail K4; the gear K311 is in engagement with the rack K5, and the motor drives the gear K311 to rotate to cause the housing K2 to be moved along the sliding rail K4 and rack K5. At the same time, the transmission shaft K31 drives the second mechanical arm K1 to rotate to shake the first cup or second cup, allowing the objects inside the first cup a second cup to be mixed together well.

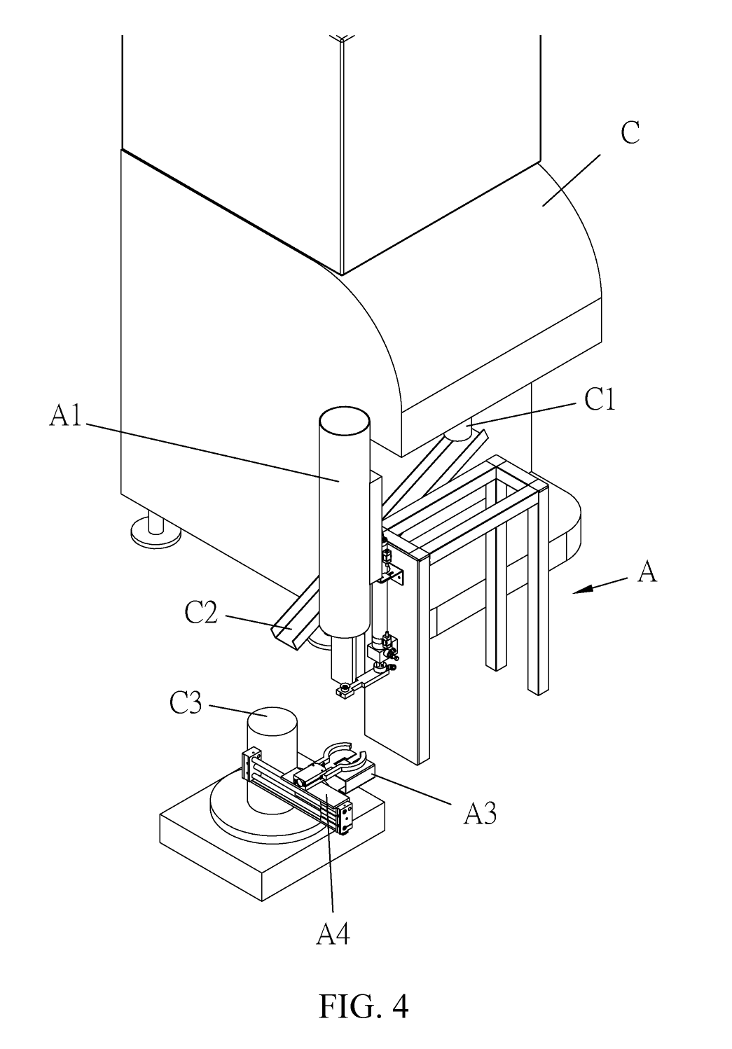

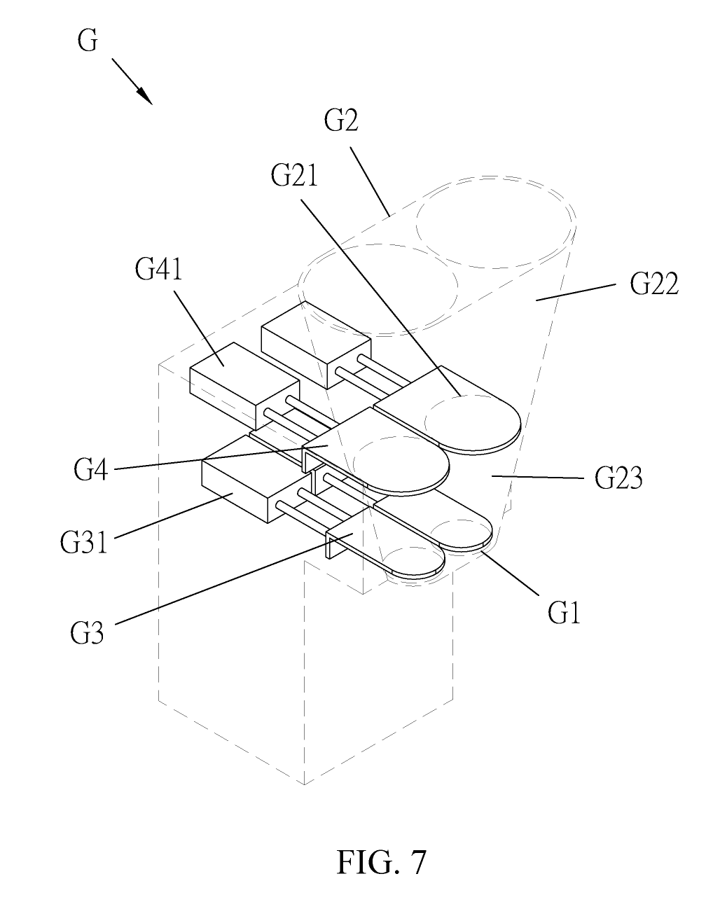

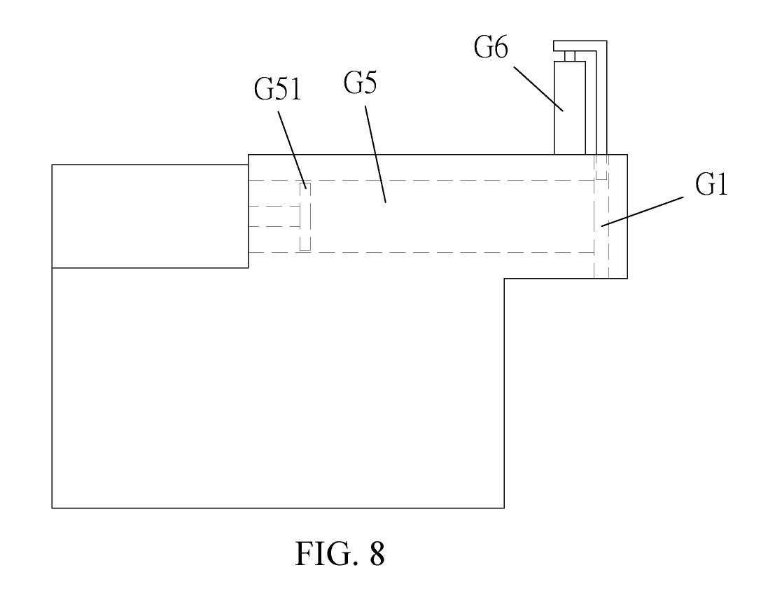

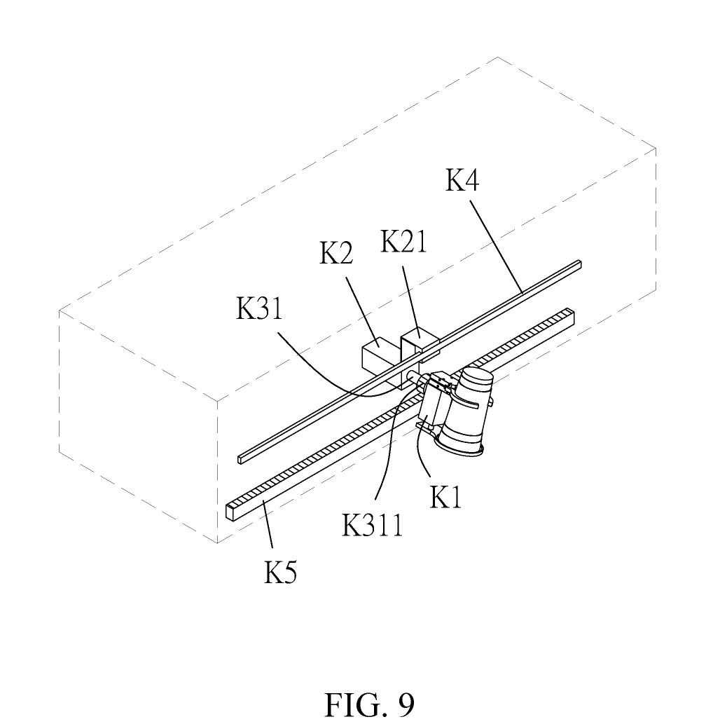

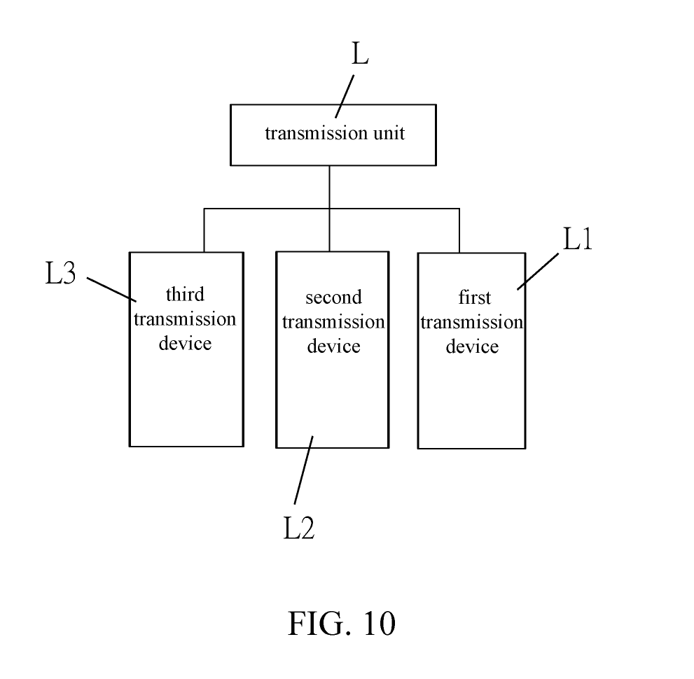

Referring to FIGS. 1 to 10 again, the transmission unit L includes a first transmission device L1, second transmission device L2 and third transmission device L3, where the first transmission device L1 includes a first rail L11 and first clamping device L12, the second transmission device L2 a second rail L21 and second clamping device L22, and the third transmission device L3 a third rail L31 and third clamping device L32, where the first rail L11 is configured in front of the ice maker C, first additive device D and fructose machine E, and the first clamping device 12 is reciprocatively configured on the first rail L11; the second rail 22 is configured in front of the fructose machine E, jam machine F, second additive device G and beverage device I, and the second clamping L22 is reciprocatively configured on the second rail 21; the third rail 31 is configured in front of the beverage device 1 and sealing machine J, and the third clamping device L32 is reciprocatively configured on the third rail L31; and the first clamping device L12, second clamping device L22 and third clamping device L32 are respectively used to clamp the first cup and second cup.

I claim:

1. An automatic beverage apparatus, comprising:
an ordering operation unit, comprising at least one beverage menu, ice menu and sugar menu, said beverage menu comprising at least one first beverage and at least one second beverage, said ice menu and sugar menu adapted to set ice volume and sugar amount corresponding to said first beverage and second beverage, said beverage menu, ice menu and sugar menu respectively outputting a first beverage signal and second beverage signal after selection;
a host computer, in electric connection with said ordering operation unit and adapted to receive said first beverage signal and second beverage signal, and said host computer also adapted to set first additive information, jam amount information and second additive information corresponding to said first beverage or second beverage;
a cup dropping machine, including a tube, lifting unit and platform, said tube adapted to accept a plurality of cups, said lifting unit configured at one side of said tube and adapted to be driven to take down a first cup and second cup in sequence after receiving said first beverage signal and said second beverage signal, said platform positioned below said tube and adapted to allow said first cup and second cup to be placed thereon, and a push unit configured at one side of said platform;
a label machine, adjacent to said cup dropping machine and adapted to be in electric connection with said host computer, said label machine also in electric connection with a label take-up unit, said label machine outputting a first label corresponding to said first beverage and second label corresponding to said second beverage after receiving said first beverage signal and second beverage signal, said label take-up unit taking up said first label and second label in sequence and sticking said first label and second label in sequence onto said first cup and second cup, and said push unit driven to move said first cup to separate from said platform to allow said second cup to enter said platform after said first label is stuck on said first cup;
an ice maker, in electric connection with said host computer and adapted to make, store and output ice cubes, said ice maker also having an ice cube outlet, said first cup positioned below said ice cube outlet, a transmission unit moving said first cup after said first cup is filled with ice cubes and at the same time, said second cup moved by said push unit to below said ice cube outlet;
a first additive device, in electric connection with said host computer and adapted to store at least one first additive, said first additive device also comprising a first mechanical arm, said transmission unit moving said first cup and second cup in sequence to in front of first additive device, and said host computer selectively driving said first mechanical arm to dig up said first additive and placing said dug first additive into said first cup or second cup according to said first additive information;
a fructose machine, in electric connection with said host computer and adapted to store fructose, said fructose machine also having a fructose outlet, said transmission unit moving said first cup and second cup in sequence to below said fructose outlet, and said fructose machine respectively outputting an amount of sugar corresponding to said first beverage into said first cup and an amount of sugar corresponding to said second beverage into said second cup according to said first beverage signal and second beverage signal;
a jam machine, in electric connection with said host computer and adapted to store jam, said jam machine also having a jam outlet, said transmission unit moving said first cup and second cup in sequence to below said jam outlet, and said host computer driving said jam machine selectively to output jam into said first cup or said second cup according said jam amount information;
a second additive device, in electric connection with said host computer and storing at least one second additive, said second additive device having at least one second additive outlet, said transmission unit moving said first cup and second cup in sequence to below said second additive outlet, and said host computer driving said second additive device selectively to output at least one second additive into said first cup or second cup according to said second additive information;
a beverage device, in electric connection with said host computer, and adapted to store a plurality of beverages, said beverage device also having a plurality of beverage outlets, said transmission unit moving said first cup and second cup to below said beverage outlets, and said host computer driving said beverage device to output a beverage corresponding to said first beverage into said first cup and output a beverage corresponding to said second beverage into said second cup according to said first beverage signal and second beverage signal;
a sealing machine, in electric connection with said host computer and installed with a plurality of sealing films, said transmission unit moving said first cup and second cup in sequence to below said sealing machine, and said sealing machine outputting a sealing film in sequence to respectively seal said first cup and second cup; and
a cup shaking device, in electric connection with said host computer, said cup shaking device comprising a second mechanical arm, and said second mechanical arm taking and rotating said first cup and second cup in sequence and placing said first cup and second cup into an order pickup area after said first cup and second cup are sealed with said sealing films.

2. The apparatus according to claim 1, wherein said lifting unit is configured with a sucking disk facing a bottom of said tube, said sucking disk draws a bottom of said first cup, said lifting unit is lowered down to cause said first cup to be separated from said tube and then lifted and returned after placing said first cup or second cup on said platform adjacent to said transmission unit.

3. The apparatus according to claim 1, wherein said transmission unit comprises a first transmission device, second transmission device and third transmission device, said first transmission device comprises a first rail and first clamping device, said second transmission device a second rail and second clamping device, said third transmission device a third rail and third clamping device, said first rail is configured in front of said ice maker, first additive device and fructose machine, said first clamping is reciprocated on said first rail, said second rail is configured in front of said fructose machine, jam machine, second additive device and beverage device, said second clamping device is reciprocated on said second rail, said third rail is configured in front of said beverage device and sealing machine, said third clamping device is reciprocated on said third rail, and said first clamping device, second clamping device or third clamping device is used to clamp said first cup and second cup.

4. The apparatus according to claim 2, wherein said transmission unit comprises a first transmission device, second transmission device and third transmission device, said first transmission device comprises a first rail and first clamping device, said second transmission device a second rail and second clamping device, said third transmission device a third rail and third clamping device, said first rail is configured in front of said ice maker, first additive device and fructose machine, said first clamping is reciprocated on said first rail, said second rail is configured in front of said fructose machine, jam machine, second additive device and beverage device, said second clamping device is reciprocated on said second rail, said third rail is configured in front of said beverage device and sealing machine, said third clamping device is reciprocated on said third rail, and said first clamping device, second clamping device or third clamping device is used to clamp said first cup and second cup.

5. The apparatus according to claim 1, wherein said label take-up unit of said label machine comprises a reciprocating telescopic device and motor, said reciprocating telescopic device is configured with a sucking disk to draw said first label or second label, said motor drives said reciprocating telescopic device to rotate and face said platform, and said reciprocating telescopic device is extended out to cause said label on said sucking disk to be stuck on said first cup or second cup.

6. The apparatus according to claim 1, wherein a guide unit is further configured below said ice cube outlet, said guide unit has a slope, and said first cup or second cup is positioned at a tail end of said guide unit to pick up ice cubes.

7. The apparatus according to claim 6, wherein an electronic scale in electric connection with said ice maker is further configured below said ice cube outlet or below said guide unit, said first cup or second cup is placed on said electronic scale, said ice cube machine is caused to stop outputting ice cubes when the weight of said ice cubes received on said electronic scale respectively reaches ice amount of said first beverage or second beverage.

8. The apparatus according to claim 1, wherein said first additive device comprises a box, at least one storage tank and a cleaning tank are configured inside said box, said first storage tank is adapted to store said first additive, said cleaning tank cleaning fluid, two sides of said box are respectively configured with a longitudinal rail in combination with a frame, said frame is reciprocated along each said longitudinal rail, said frame is configured with a transverse rail, and said first mechanical arm is configured on said transverse rail, allowing said first mechanical arm to be reciprocated along said transverse rail.

9. The apparatus according to claim 8, wherein a top face of said box is configured with a cover, a connecting element is configured on said cover, and a top end of said connecting element is in combination with a bottom face of said frame, thereby allowing said cover to be separated from or closed on said box when said frame is reciprocated longitudinally.

10. The apparatus according to claim 8, wherein a front side of said box is protruded with a funnel, thereby allowing said first additive to be placed into said funnel and then drop into said first cup or second cup through said funnel after said first mechanical arm digs up said first additive.

11. The apparatus according to claim 1, wherein said second additive device has at least one accommodation tank, first block plate and second block plate, said second additive outlet is configured on a bottom of said accommodation tank, said first block plate is adapted to close said second additive outlet, said accommodation tank is configured with a slot adapted to install said second block plate, allowing said accommodation tank to be partitioned into a first accommodation space and second accommodation space, said first accommodation space and second accommodation space are adapted to store said second additive, said first block plate and second block plate are in connection with a first air cylinder and second air cylinder, respectively; said host computer drives said first air cylinder to cause said first block plate to be separated from said second additive outlet, allowing said second additive to drop into said first cup or second cup, said first block plate is moved by said first air cylinder to close said second additive outlet, said second air cylinder drives said second block plate to cause said second additive in said first accommodation space to drop into said second accommodation space, and said second air cylinder then drives said second block plate to enter said accommodation tank through said slot.

12. The apparatus according to claim 1, wherein said second additive device has at least one hollow accommodation cylinder adapted to store said second additive, a bottom of said accommodation cylinder is configured with a screw rod to push said second additive, said second additive outlet is configured on a top of said accommodation cylinder, said second additive outlet is configured with a push air cylinder, and said push air cylinder pushes said second additive, allowing said second additive to drop into said first cup or second cup through said second additive outlet.

13. The apparatus according to claim 1, wherein said cup shaking device comprises a housing, motor having a transmission shaft, sliding rail and rack, said motor is configured inside said housing, said transmission shaft is extended to the outside of said housing and configured with a gear, said second mechanical arm is also configured on said transmission shaft, said housing is extended out with a suspension arm slidably configured on said sliding rail, said rack is positioned below said sliding rail, said gear is in engagement with said rack, said motor drives said gear to rotate, allowing said housing to be moved along said rail and rack, and at the same time, said transmission shaft drives said second mechanical arm to rotate to shake said first cup or second cup.

14. The apparatus according to claim 1, wherein said host computer is in electric connection with a milk machine, and said host computer is adapted to set milk amount corresponding to said first beverage or second beverage.
